(19) United States
(12) Patent Application Publication
(10) Pub. No.: US 2022/0217673 A1
(43) Pub. Date: Jul. 7, 2022

(54) POSITIONING MEASUREMENT REPORTING FOR MOBILE RADIO NETWORK NODES

(71) Applicant: Telefonaktiebolaget LM Ericsson (publ), Stockholm (SE)

(72) Inventors: Ali Zaidi, Norrköping (SE); Ritesh Shreevastav, Upplands Väsby (SE); Fredrik Gunnarsson, Linköping (SE); Henrik Rydén, Stockholm (SE); Satyam Dwivedi, Solna (SE); Sara Modarres Razavi, Linköping (SE)

(21) Appl. No.: 17/611,314

(22) PCT Filed: May 15, 2019
(86) PCT No.: PCT/SE2019/050440

§ 371 Date: Nov. 15, 2021

(51) Int. Cl. H04W 64/00; G01S 1/04; G01S 5/00; G01S 5/02

(52) U.S. Cl. CPC H04W 64/00; G01S 5/0236; G01S 5/0036; G01S 1/0426

(57) ABSTRACT

Systems and methods for providing measurement reporting for mobile radio network nodes are provided. Embodiments of a method performed by a user equipment (UE) comprise obtaining, from a location server, positioning assistance information comprising information for mobile radio network nodes and their corresponding downlink signal configurations, and measuring one or more positioning parameters corresponding to each of one or more mobile radio network nodes. In another embodiment, a method performed by a location server comprises determining mobile radio network nodes in a vicinity of a UE, and sending, to the UE, positioning assistance information comprising information for mobile radio network nodes and their corresponding downlink signal configurations. The method further comprises receiving, from the UE, a positioning measurement report and either or both of a timestamp and a position stamp for each mobile radio network node, and computing the position of the UE based on the positioning measurement report.

### TECHNICAL FIELD

The present disclosure relates to a wireless communication network, and, in particular, to positioning measurement reporting for mobile radio network nodes of the wireless communication network.

### BACKGROUND

Wireless communication networks, such as cellular networks, enable various human- and machine-centric services, including providing positioning measurement reporting of user devices for various purposes. Future wireless communication networks will include mobile base stations and/or network access points (e.g., aerial base stations with adaptive altitudes, and/or base stations mounted on ground vehicles, as non-limiting examples) to provide radio connectivity. Such mobile radio network nodes can extend radio coverage to areas in which accessing mobile networks with fixed access points is difficult or impossible at present. Mobile radio network nodes are also relevant for locations and scenarios in which network access demand varies significantly over time (e.g., in a stadium, a shopping mall, a factory, an underground mine, a seaport, or a remote natural resource exploration and extraction site). Such mobile radio network nodes can also be useful to meet special quality of service (QoS) demands of users requiring accurate positioning and localization and/or users requiring communications that are highly secure, extremely reliable, and/or very high-speed.

The network of mobile radio network nodes can also include moving relays, which extend access to users that are difficult to reach otherwise in a cost-efficient way. Current wireless communication networks already provide relays, and enable links between relays in a manner similar to device-to-device (D2D) and vehicle-to-vehicle (V2V) sidelinks. Additionally, D2D and V2V positioning techniques and technologies are presently emerging.

Future networks will also provide connectivity to humans and devices aloft, such as drones and/or passengers in an airplane, as non-limiting examples. Positioning of such users is also important. To this end, the 3^{rd} Generation Partnership Project (3GPP) has approved a new study item on enhanced support for aerial vehicles in its Technical Specification Group (TSG) Radio Access Network (RAN) #75 plenary meeting. In terms of Long-Term Evolution (LTE) enhancements, positioning for aerial vehicles is one objective of the study item.

Small-cell solutions have traditionally targeted enhancing mobile network data rates in dense urban areas (mainly indoor locations such as stadiums, shopping malls, and the like) with high capacity demands. Motivated by operator obligations to reach 100% coverage in rural areas, another approach to the use of small cells has emerged. In this approach, mobile small cells (e.g., drones and/or balloons) are used, with drones being more suited to situations requiring fast deployment and limited subscribers, and balloons being employed in situations in which a slower deployment is acceptable, but a better deployment footprint is required.

Positioning in LTE is supported by the architecture illustrated in FIG. 1. As seen in FIG. 1, direct interactions between a user equipment (UE) 100 and a location server (i.e., an Evolved Serving Mobile Location Center, or E-SMLC) 102 are enabled via the LTE Positioning Protocol (LPP) (defined in 3GPP Technical Specification (TS) 36.355 [1]), as indicated by arrow 104. Moreover, there are also interactions between the E-SMLC 102 and the eNodeB (eNB) 106 via the LPPa protocol (defined in 3GPP TS 36.455 [2]), as indicated by arrow 108. The interactions between the E-SMLC 102 and the eNB 106 may be supported to some extent by interactions between the eNB 106 and the UE 100 using an LTE-Uu interface via the Radio Resource Control (RRC) protocol (defined by 3GPP TS 36.331 [3]), as indicated by arrow 110. Additionally, the E-SMLC 102 and mobility management entity (MME) 112 interact using an SL_{S} interface via the Location Services Application (LCS-AP) protocol (defined in 3GPP TS 29.171 [4]), as indicated by arrow 114. Likewise, the MME 112 and a gateway mobile location center (GMLC) 116 interact using an SL_{g} interface (defined in 3GPP TS 29.172 [5]), as indicated by arrow 118.

In addition to the protocols and interfaces shown in FIG. 1, the following positioning techniques are considered in LTE, as described in 3GPP TS 36.305 [6]:
Enhanced Cell ID, which provides cell identifier (ID) information to associate a UE with a serving area of a serving cell, and also provides additional information to determine a finer granularity position;
Assisted Global Navigation Satellite System (GNSS), in which GNSS information is retrieved by a UE and supported by assistance information provided to the UE from an E-SMLC.
Observed Time Difference of Arrival (OTDOA), in which a UE estimates the time difference of reference signals from different base stations, and sends time difference data to an E-SMLC for multilateration; and
Uplink Time Difference of Arrival (UTDOA), in which a UE is requested to transmit a specific waveform that is detected by multiple location measurement units (e.g., an eNB) at known positions, which then forward the measurements to an E-SMLC for multilateration.

However, non-line-of-sight (NLOS) situations are known to present challenges in the context of wireless positioning. There are presently no commercial solutions available to address such challenges and still provide sufficiently precise positioning, particularly in view of the tight expected positioning requirements in 5G wireless communication networks. Additionally, in rural areas, one challenging issue for wireless communication network positioning is the sparse network deployment resulting in very large inter-site distance (ISD) between macro cells. While GNSS positioning may provide sufficient positioning functionality in these areas, GNSS receivers often are too expensive in terms of cost and energy consumption to be included in many massive machine-type communication (MTC) devices such as Narrowband Internet of Things (IoT) devices.

### SUMMARY

Systems and methods are disclosed herein for enabling positioning measurement reporting for mobile radio network nodes. Embodiments of a method performed by a user equipment (UE) in a wireless communication system comprise obtaining, from a location server, positioning assistance information comprising information for one or more mobile radio network nodes and their corresponding downlink signal configurations. The method further comprises measuring one or more positioning parameters corresponding to each of at least one mobile radio network node, the at least one mobile radio network node being at least one of the one or more mobile radio network nodes for which the positioning assistance information was obtained. In some embodiments, the method also comprises generating a positioning measurement report for the at least one mobile radio network node based on the one or more positioning parameters, and sending, to the location server, the positioning measurement report and either or both of a timestamp and a position stamp for each of the at least one mobile radio network node to the location server.

Some embodiments further provide that the method additionally comprises determining a position of the UE based on the one or more positioning parameters. In some such embodiments, determining the position of the UE is further based on a downlink signal from the at least one mobile radio network node and either or both of a timestamp and a position stamp for each of the at least one mobile radio network node, wherein the downlink signal comprises either or both of the timestamp and the position stamp, the timestamp is indicative of a time of transmission of the downlink signal by the corresponding at least one mobile radio network node, and the position stamp is indicative of a position of the corresponding at least one mobile radio network node at the time of transmission of the downlink signal by the corresponding at least one mobile radio network node. According to some such embodiments, determining the position of the UE is further based on a position for each of the at least one mobile radio network node, at a corresponding time of transmission of a downlink signal by each of the at least one radio network node, obtained from the positioning assistance information.

In some embodiments, prior to obtaining the assistance information, the method further comprises receiving, from the location server, a UE capability request, and responsive to receiving the UE capability request, providing, to the location server, a UE capability response indicating the UE's capability for performing and reporting measurements for the mobile radio network nodes. Some embodiments provide that the one or more positioning parameters comprises:
a time of arrival of a downlink signal of a first mobile radio network node of the at least one mobile radio network node;
a difference in time of arrival of a downlink signal of a second mobile radio network node of the at least one mobile radio network node and a downlink signal of a fixed radio network node;
a difference in time of arrival of downlink signals of a third mobile radio network node and a fourth mobile radio network node of the at least one mobile radio network node;
a received signal strength of a fifth mobile radio network node of the at least one mobile radio network node; and/or
an angle of arrival of a sixth mobile radio network node of the at least one mobile radio network node.

Embodiments of a method performed by a location server in a wireless communication system for enabling positioning measurement reporting for mobile radio network nodes are also disclosed. The method comprises determining one or more mobile radio network nodes in a vicinity of a UE, and sending, to the UE, positioning assistance information comprising information for the one or more mobile radio network nodes and their corresponding downlink signal configurations. The method also comprises receiving, from the UE, a positioning measurement report and either or both of a timestamp and a position stamp for each of at least one mobile radio network node, the at least one mobile radio network node being at least one of the one or more mobile radio network nodes for which the positioning assistance information was sent, wherein the timestamp is indicative of a time of transmission of a downlink signal by the corresponding at least one mobile radio network node, and the position stamp is indicative of a position of the corresponding at least one mobile radio network node at the time of transmission of the downlink signal by the corresponding at least one mobile radio network node. The method additionally comprises computing the position of the UE based on the positioning measurement report. In some embodiments, determining the one or more mobile radio network nodes in the vicinity of the UE is based on one or more serving cell identities (IDs).

In some embodiments, the method further comprises, prior to determining the one or more mobile radio network nodes in the vicinity of the UE, sending, to the UE, a UE capability request. The method also comprises obtaining, from the UE, a UE capability response indicating the UE's capability for performing and reporting measurements for the mobile radio network nodes. According to such embodiments, determining the one or more mobile radio network nodes in the vicinity of the UE is based on the UE capability response. Some embodiments provide that the method also comprises, subsequent to determining the one or more mobile radio network nodes in the vicinity of the UE, sending, to a mobile radio network node of the one or more mobile radio network nodes, a status information request, and obtaining, from the mobile radio network node of the one or more mobile radio network nodes, a status information response comprising status information.

In some embodiments, sending the positioning assistance information comprises sending a conventional location assistance information signal, or sending a location assistance information signal corresponding only to the one or more mobile radio network nodes in the vicinity of the UE. According to some embodiments, the method additionally comprises requesting each of the at least one mobile radio network node to perform a location update based on a positioning estimation accuracy of the UE (e.g., if the positioning estimation accuracy of the UE, as calculated by comparing the positioning measurement report generated by the UE with alternate positioning measurements, is determined to be insufficiently precise).

Embodiments of a method performed by a mobile radio network node in a wireless communication system for enabling positioning measurement reporting for mobile radio network nodes are also disclosed. The method comprises periodically transmitting a downlink signal with either or both of a timestamp and a position stamp. In some embodiments, the method further comprises receiving, from the location server, a status information request, and responsive to receiving the status information request from the location server, sending a status information response comprising status information to the location server. According to some such embodiments, the status information comprises:
an indication of whether the mobile radio network node is transmitting a downlink signal;
an indication of whether the mobile radio network node is moving;
an indication of a speed of the mobile radio network node;
one more position reports with a corresponding one or more timestamps;
a downlink signal configuration of the mobile radio network node;
a corresponding fixed macro-cell deployment; and/or
an indication of whether the mobile radio network node is a relaying node or is capable of operating as a reference node for UE positioning.

Some embodiments provide that the status information comprises the one or more position reports, and the one or more position reports are based on a latitude and a longitude of the mobile radio network node, a trajectory of the mobile radio network node, an internal measurement unit (IMU) of the mobile radio network node, one or more distances to a corresponding one or more neighboring network nodes of the mobile radio network node, and/or one or more positions of a corresponding one or more neighboring network nodes of the mobile radio network node. In some such embodiments, the one or more position reports are based on the latitude and the longitude of the mobile radio network node as measured by a global navigation satellite system (GNSS) receiver of the mobile radio network node and/or a real-time kinematic (RTK) receiver of the mobile radio network node. Some such embodiments provide that the one or more position reports are based on the latitude and the longitude of the mobile radio network node based on a Wi-Fi beacon and/or a Bluetooth beacon.

Embodiments of a UE of a wireless communication system adapted to perform methods described above are also disclosed.

Embodiments of a UE of a wireless communication system are also disclosed. The UE comprises a transceiver and processing circuitry associated with the transceiver. The processing circuitry is configured to perform methods described above.

Embodiments of a network node adapted to perform methods described above are also disclosed.

Embodiments of a network node are also disclosed. The network node comprises a network interface and processing circuitry associated with the network interface. The processing circuitry is configured to perform methods described above.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a block diagram illustrating exemplary protocols and interfaces employed by Long Term Evolution (LTE) wireless communication networks for providing architectural support for positioning;

FIG. 2 illustrates one example of a cellular communications network according to some embodiments of the present disclosure;

FIG. 3 is a block diagram illustrating establishment of a multi-hop route between fixed base stations and a user equipment (UE) using multiple mobile radio network nodes;

FIGS. 4A and 4B illustrate signaling among and operations performed by a UE, a location server, and at least one mobile radio network node for providing positioning measurement reporting for the mobile radio network node(s);

FIG. 5 is a flowchart illustrating operations of a UE for measuring positioning parameters for at least one mobile radio network node;

FIG. 6 is a flowchart illustrating operations of a location server for computing the position of a UE based on a positioning measurement report provided by the UE;

FIG. 7 is a flowchart illustrating operations of a mobile radio network node for providing a downlink signal and, optionally, a status information response for use in positioning measurement reporting;

FIG. 8 is a schematic block diagram of a radio access node according to some embodiments of the present disclosure;

FIG. 9 is a schematic block diagram that illustrates a virtualized embodiment of the radio access node of FIG. 8 according to some embodiments of the present disclosure;

FIG. 10 is a schematic block diagram of the radio access node of FIG. 8 according to some other embodiments of the present disclosure;

FIG. 11 is a schematic block diagram of a User Equipment device according to some embodiments of the present disclosure; and

FIG. 12 is a schematic block diagram of the UE of FIG. 11 according to some other embodiments of the present disclosure.

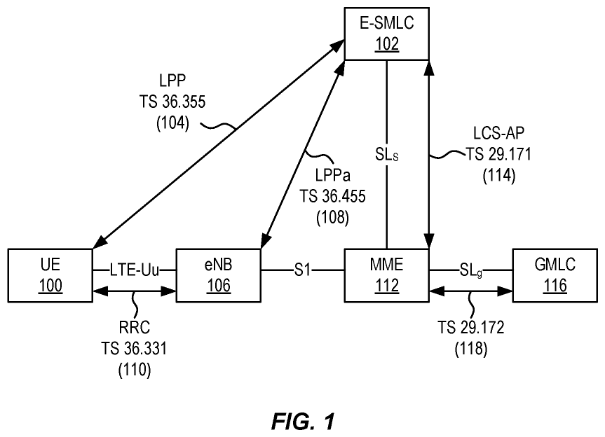

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a 3GPP 5G NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Entity: As used herein, a “core network entity” is any type of entity in a core network. A core network entity may also sometimes be referred to herein as a “core network node”. Some examples of a core network entity include, e.g., a Mobility Management Entity (MME), a Packet Data Network Gateway (P-GW), a Service Capability Exposure Function (SCEF), or the like in an Evolved Packet Core (EPC). Some other examples of a core network entity include, e.g., an Access and Mobility Management Function (AMF), a Network Slice Selection Function (NSSF), an Authentication Server Function (AUSF), a Unified Data Management (UDM), a Session Management Function (SMF), a Policy Control Function (PCF), an Application Function (AF), a Network Exposure Function (NEF), a User Plane Function (UPF), or the like in a 5G Core (5GC). A core network entity may be implemented as a physical network node (e.g., including hardware or a combination of hardware and software) or implemented as a functional entity (e.g., as software) that is, e.g., implemented on a physical network node or distributed across two or more physical network nodes.

Wireless Device: As used herein, a “wireless device” is any type of device that has access to a cellular communications network by wirelessly transmitting and/or receiving signals to a radio access node(s). Some examples of a wireless device include, but are not limited to, a User Equipment device in a 3GPP network and a Machine Type Communication device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Systems and methods for providing positioning measurement reporting for mobile radio network nodes are disclosed herein.

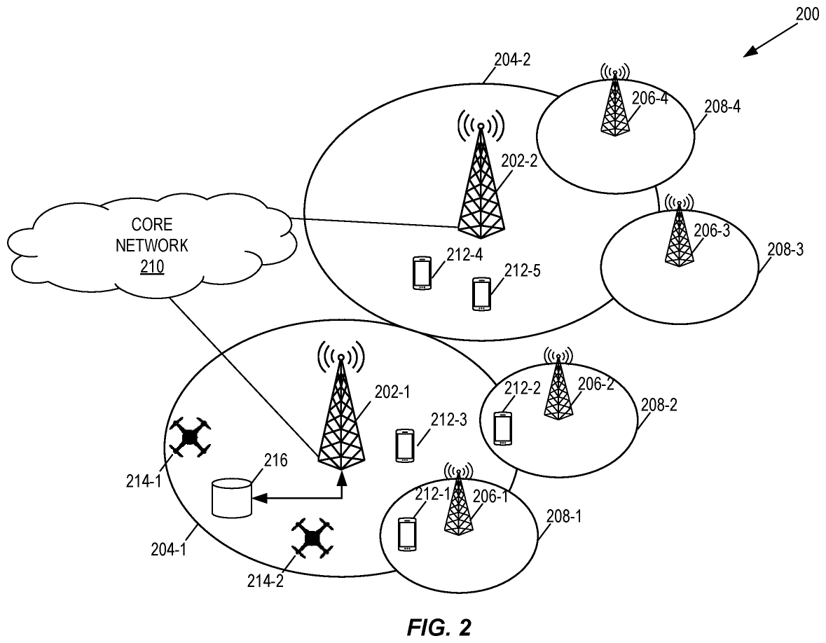

In this regard, FIG. 2 illustrates one example of a wireless communication network 200 (e.g., a cellular communications network) according to some embodiments of the present disclosure. In some embodiments, the wireless communication network 200 is an LTE network or a 5G NR network. In this example, the wireless communication network 200 includes base stations 202-1 and 202-2, which in LTE are referred to as eNBs and in 5G NR are referred to as gNBs, controlling corresponding macro cells 204-1 and 204-2. The base stations 202-1 and 202-2 are generally referred to herein collectively as base stations 202 and individually as base station 202. Likewise, the macro cells 204-1 and 204-2 are generally referred to herein collectively as macro cells 204 and individually as macro cell 204. The wireless communication network 200 may also include a number of low power nodes 206-1 through 206-4 controlling corresponding small cells 208-1 through 208-4. The low power nodes 206-1 through 206-4 can be small base stations or Remote Radio Heads, or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The base stations 202 are connected to a core network 210.

The base stations 202 and the low power nodes 206 provide service to wireless devices 212-1 through 212-5 in the corresponding cells 204 and 208. The wireless devices 212-1 through 212-5 are generally referred to herein collectively as wireless devices 212 and individually as wireless device 212. The wireless devices 212 are also sometimes referred to herein as UEs. The base stations 202 may also be communicatively coupled to a location server (i.e., an Evolved Serving Mobile Location Center, or E-SMLC), such as the location server 216. The location server 216 is configured to collect positioning measurements and other location information from, e.g., the base stations 202, the wireless devices 212, and/or other devices within the wireless communication network 200, and assisting devices with positioning measurements and estimations.

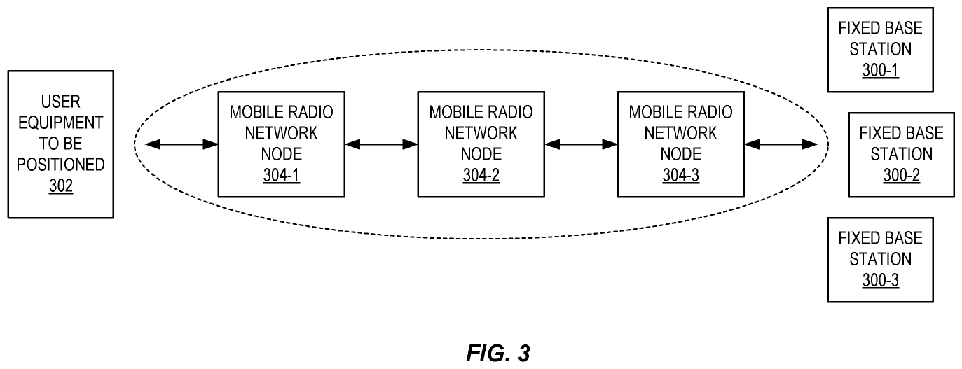

To address the challenges described above with respect to, e.g., non-line-of-sight (NLOS) scenarios and/or sparse network deployment with large inter-site distance (ISD) between macro cells, one or more mobile radio network nodes 214 (e.g., mobile radio network nodes 214-1 and 214-2) are provided for positioning purposes. Each of the mobile radio network nodes 214 is equipped with a small cell and is connected via wireless backhaul to the wireless communication network 200 (e.g., via a macro cell, or via another of the mobile radio network nodes 214). The mobile radio network nodes 214 each provide a relay between base stations (e.g., the base stations 202) and mobile units (i.e., the wireless devices 212) for positioning purposes, and thus can provide mobile node positioning in spite of an NLOS link between mobile units and base stations. In some embodiments, multiple mobile radio network nodes 214 may connect to each other in sequence to create a chain of relays providing a multi-hop route between the base stations 202 and the wireless devices 212. Multi-hop routes and factors affecting their establishment and positioning measurements are discussed in greater detail below with respect to FIG. 3.

The use of a set of mobile radio network nodes 214 acting as mobile network access points and/or moving relays enables the degree of freedom in their mobility to be used to accurately determine a position of a particular user or group of users of the wireless devices 212 and/or a position of other moving access points and relays. For example, a multi-hop connection can be established between moving access points and relays, taking into account positioning requirements of users, relays, and access points, their sensing and measuring capabilities, and other quality of service (QoS) requirements that may exist. An illustration is shown in FIG. 3, which illustrates establishment of a multi-hop route between fixed base stations 300 and a UE 302 using multiple mobile radio network nodes 304 (e.g., the mobile radio network nodes 214 of FIG. 2, as non-limiting examples).

The accuracy of radio based positioning techniques (e.g., based on time of arrival and angle of radio arrival signals) relies heavily on the reception of sufficiently strong line-of-sight (LOS) signals at the receiving device or node. Consequently, positioning accuracy may be significantly degraded in the absence of LOS signal reception. This is different from other QoS requirements, where absence of LOS is often not a major issue because several reflected signals, when combined properly, can enhance performance.

Therefore, a multi-hop route, such as that illustrated in FIG. 3, that is established with positioning requirements in mind may be very different from a multi-hop route that is established to satisfy other QoS requirements for communication. The criteria for establishing (and dynamic re-establishing) a multi-hop route between mobile radio network nodes may include consideration of the following:
Required positioning accuracy of the mobile radio network nodes to be positioned;
Radio propagation conditions (e.g., achieving LOS signal receptions between mobile radio network nodes);
Sensing capabilities of mobile radio network nodes (e.g., provision of different sensors and their measurement performance, wherein the sensors can be of various types such as sensors for vision, radio signal reception, inertial, magnetic field measurement, and/or air pressure measurement, and the like);
Radio signal transmission and reception capabilities (e.g., transceivers equipped with different antenna capabilities for transmission and/or reception);
Availability of anchor points in the environment (e.g., signatures placed in the environment to support highly accurate positioning of some mobile radio network nodes in the multi-hop route, through sensors such as cameras);
Constraints associated with mobility of mobile radio network nodes, given that some mobile radio network nodes have higher flexibility (e.g., flying mobile radio network nodes in air);
Network geometry (e.g., geometric dilution of precision for trilateration-based techniques like the Observed Time Difference of Arrival (OTDOA) positioning method employed in LTE);
Diversity and density of mobile radio network nodes to be positioned;
Availability of reliable power source to mobile radio network nodes (e.g., battery life and battery recharge capability using techniques such as energy harvesting); and
Other QoS requirements.

Once a multi-hop route is established, positioning measurements can be reported to the wireless communication network in various ways. Selection of an appropriate measurement reporting protocol can depend on factors such as the following:
Which mobile radio network nodes in the network accurately know their own position;
Whether a positioning request is initiated by the wireless communication network, by the mobile radio network node to be positioned, or by an external entity;
Whether a multi-hop route can be reconfigured before measurement reporting is complete (which would require checking that reporting is done even if route is reconfigured); and
Any positioning requirements that impact granularity of the measurement report and reliability of the reporting protocol.

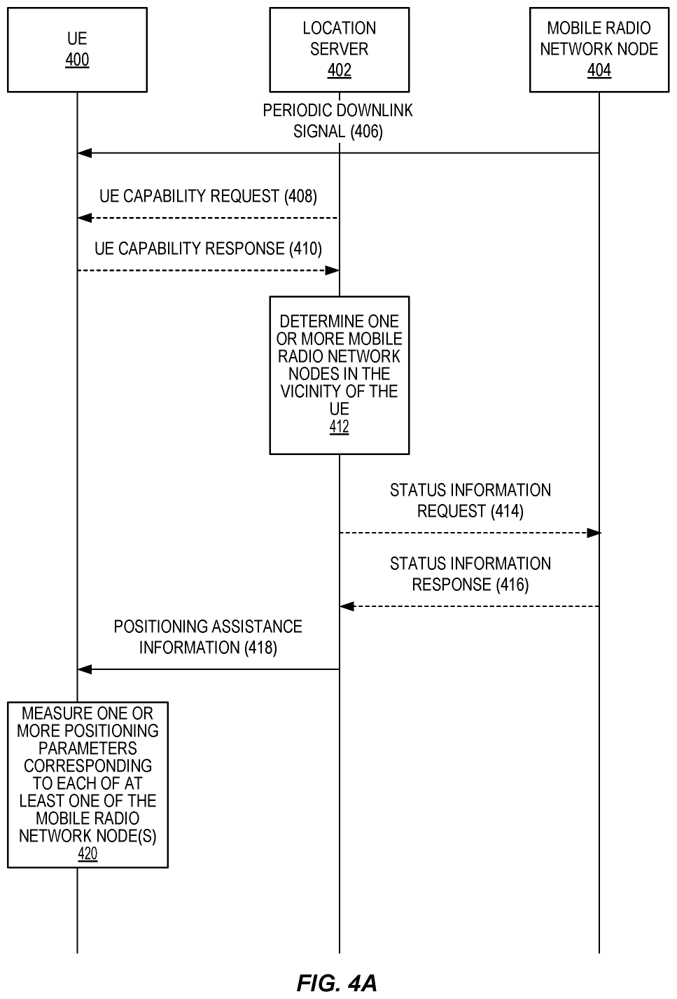

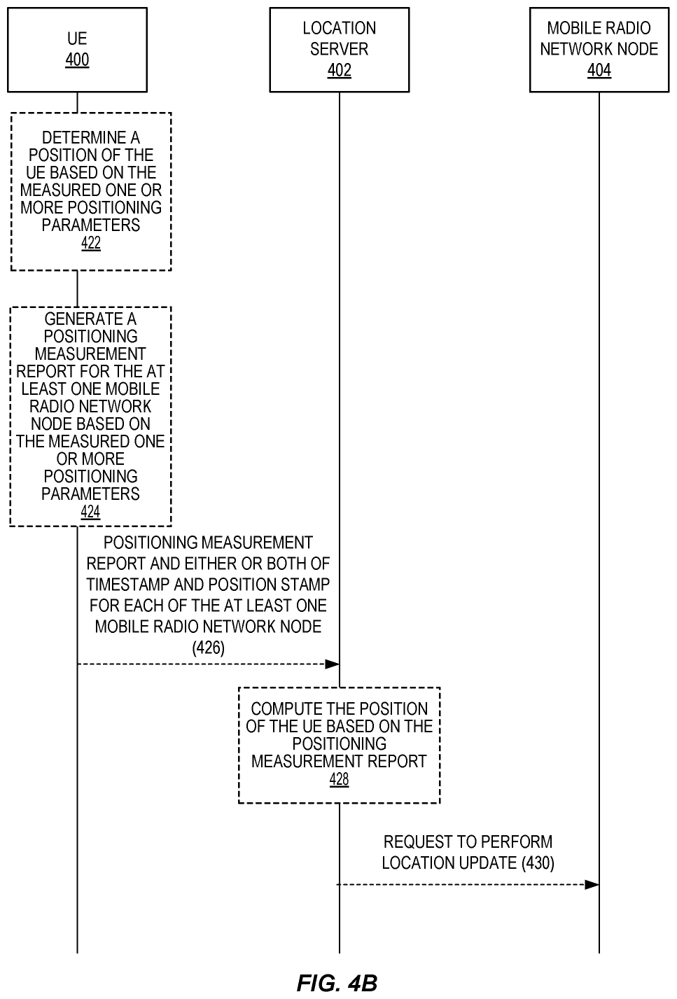

FIGS. 4A and 4B illustrate signaling among and operations performed by a UE 400 (e.g., the wireless devices 212 of FIG. 2), a location server 402 (e.g., the location server 216 of FIG. 2), and a mobile radio network node 404 (e.g., one of the mobile radio network nodes 214 of FIG. 2) for providing positioning measurement reporting for the mobile radio network node(s). Signaling between the UE 400, the location server 402, and the mobile radio network node(s) 404 is indicated by arrows between the vertical lines corresponding to those elements, while operations performed by the UE 400, the location server 402, and the mobile radio network node(s) 404 are represented by blocks positioned over the vertical lines corresponding to those elements.

As seen in FIG. 4A, the mobile radio network node 404 periodically transmits a downlink signal with either or both of a timestamp and a position stamp to the UE 400, as indicated by arrow 406. The timestamp indicates a time at which the downlink signal was transmitted by the mobile radio network node 404, and the position stamp indicates a position of the mobile radio network node 404 at the time that it transmitted the downlink signal. Note that although only one arrow 406 is shown in FIGS. 4A and 4B, it is to be understood that the transmission of the downlink signal with the timestamp and/or the position stamp is performed at periodic intervals by the mobile radio network node 404. In some embodiments, the location server 402 may send a UE capability request to the UE 400, as indicated by arrow 408. The UE capability request may seek information regarding the capability of the UE 400 for performing and reporting measurements for the mobile radio network nodes in accordance with the present disclosure. In response, the UE 400 in such embodiments may provide a UE capability response indicating its capability for performing and reporting measurements for the mobile radio network nodes, as indicated by arrow 410. As one example alternative, the UE 400 may provide its capability information to the location server 402 without first receiving a request. As another example alternative, the location server 402 may obtain the capability information of the UE 400 from some other network node.

The location server 402 next determines one or more mobile radio network nodes 404 in the vicinity of the UE 400, as indicated by block 412. This determination may be based on the UE capability response provided by the UE 400, and/or may be provided based on data already available to the location server 402, such as one or more serving cell identities (IDs). In the latter case, the location server 402 may run a cell-ID-based positioning process, whereby the location server 402 may obtain the serving cell ID of the UE 400. Using the serving cell ID of the UE 400, the location server 402 may identify one or more mobile radio network nodes 404 that serve one or more cells (e.g., one or more neighbor cells of the serving cell of the UE 400) in the vicinity of the UE 400.

According to some embodiments, after determining the one or more mobile radio network nodes 404 in the vicinity of the UE 400, the location server 402 optionally may send a status information request to the mobile radio network nodes 404, as indicated by arrow 414. Note that FIGS. 4A and 4B only show one of the one or more mobile radio network nodes 404 for simplicity and ease of discussion. Using the illustrated mobile radio network node 404 as an example, the mobile radio network node 404 may respond by sending a status information response to the location server 402, as indicated by arrow 416. The status information response provided by the mobile radio network node 404 may include the following:
an indication of whether the mobile radio network node 404 is transmitting a downlink signal;
an indication of whether the mobile radio network node 404 is moving;
an indication of a speed and direction of movement of the mobile radio network node 404;
one more position reports with a corresponding one or more timestamps that indicate past and/or future positions of the mobile radio network node 404 and the times at which the mobile radio network node 404 was or will be at those positions;
a downlink signal configuration of the mobile radio network node 404;
a corresponding fixed macro-cell deployment; and/or
an indication of whether the mobile radio network node 404 is a relaying node or is capable of operating as a reference node for UE positioning.

According to some embodiments, a position report included in the status information response provided by the mobile radio network node 404 includes information that enables the location server and/or the UE 400 to determine the position of the mobile radio network node 404 at different points in time (i.e., the points in time at which the mobile radio network node 404 transmits its downlink signal). This is particularly beneficial in embodiments in which the downlink signal of the mobile radio network node 404 includes a timestamp but not a position stamp (e.g., in embodiments in which the position of the mobile radio network node 404 at the time of transmitting its downlink signal is otherwise known to or able to be determined by the location server and/or the UE 400). As one example, the position report may include a current position of the mobile radio network node 404 (e.g., a latitude and a longitude of the mobile radio network node 404), a trajectory of the mobile radio network node 404, an internal measurement unit (IMU) of the mobile radio network node 404, one or more distances to corresponding one or more neighboring network nodes of the mobile radio network node 404, and/or one or more positions of the corresponding one or more neighboring network nodes of the mobile radio network node 404. The position report in some embodiments may be based on the latitude and the longitude of the mobile radio network node as measured by a GNSS receiver of the mobile radio network node 404 and/or a real-time kinematic (RTK) receiver of the mobile radio network node 404. Some embodiments may provide that the position report is based on the latitude and the longitude of the mobile radio network node 404 based on a Wi-Fi beacon and/or a Bluetooth beacon.

The location server 402 then sends positioning assistance information, including information for mobile radio network nodes 404 and their corresponding downlink signal configurations, to the UE 400, as indicated by arrow 418. In some embodiments, the positioning assistance information may include a conventional location assistance information signal, or may be a location assistance information signal corresponding only to the one or more mobile radio network nodes 404 in the vicinity of the UE 400. Some embodiments may provide that the positioning assistance information is based on (includes information from and/or information derived from) the status information response received by the location server 402 from the mobile radio network node(s) 404.

Upon obtaining the positioning assistance information from the location server 402, the UE 400 measures one or more positioning parameters corresponding to each of at least one of the one or more mobile radio network nodes 404, as indicated by block 420. In some embodiments, for each of the at least one of the one or more mobile radio network nodes 404, the one or more positioning parameters may include the following:
a time of arrival of the downlink signal of the mobile radio network node 404;
a difference in time of arrival of the downlink signal of the mobile radio network node 404 and a downlink signal of a fixed radio network node;
a difference in time of arrival of the downlink signal of the mobile radio network node 404 and a downlink signal of another (e.g., reference) one of the one or more mobile radio network nodes 404;
a received signal strength of the mobile radio network node 404; and/or
an angle of arrival of the downlink signal for the mobile radio network node 404.

Each of the exemplary positioning parameters listed above may be provided in combination with either or both of a timestamp and a position stamp included in the corresponding downlink signals of the mobile radio network nodes 404. In embodiments in which one or more position parameters includes only a timestamp of the downlink signal(s) provided by the mobile radio network nodes 404, the UE 400 may use information provided in the positioning assistance information sent by the location server 402 to determine locations of the mobile radio network nodes 404 at the times indicated by the corresponding timestamps.

Turning now to FIG. 4B, in some embodiments, the UE 400 itself may then determine a position of the UE 400 based on the measured one or more positioning parameters and, in some embodiments, the positioning assistance information received from the location server, as indicated by block 422. In doing so, the UE 400 may use suitable type of positioning technique such as, e.g., a multilateration technique. Since such techniques are well-known, they are not repeated herein. Optionally, the UE 400 may then report its position to a network node and/or use its position for one or more actions (not illustrated). Some embodiments may provide that determining the position of the UE 400 may be further based on respective one or more downlink signals from the one or more mobile radio network nodes (such as the downlink signal from the mobile radio network node 404) and either or both of a timestamp and a position stamp for each of the one or more mobile radio network nodes in the vicinity of the UE 400. Determining the position of the UE 400 according some embodiments may be further based on a position for each of the one or more mobile radio network nodes obtained from the positioning assistance information provided by the location server 402.

Alternately or additionally, some embodiments of the UE 400 may generate a positioning measurement report for at least one of the one or more mobile radio network nodes based on the measured one or more positioning parameters, as indicated by block 424. The UE 400 in such embodiments may then send the positioning measurement report and either or both of a timestamp and a position stamp for each of the at least one mobile radio network node to the location server 402, as indicated by arrow 426. The location server 402 may then compute the position of the UE 400 based on the positioning measurement report received from the UE 400, as indicated by block 428. According to some embodiments, the location server 402 may send to the mobile radio network node 404 a request to perform a location update based on a positioning estimation accuracy of the UE 400, as indicated by arrow 430. As a non-limiting example, the positioning estimation accuracy of the UE 400 may be calculated as an offset between the position of the UE 400 based on the positioning measurement report generated by the UE 400 and one or more alternate positioning measurements (provided by, e.g., a Global Positioning System (GPS) positioning measurement by the UE 400 and/or positioning measurements of the UE by stationary base stations). If the positioning estimation accuracy of the UE 400 is determined to be insufficiently precise, the location server 402 may request that the mobile radio network nodes 404 perform a location update so that subsequent positioning parameters for the mobile radio network node 404 as measured by the UE 400 enable the UE 400 to generate a more accurate positioning measurement report.

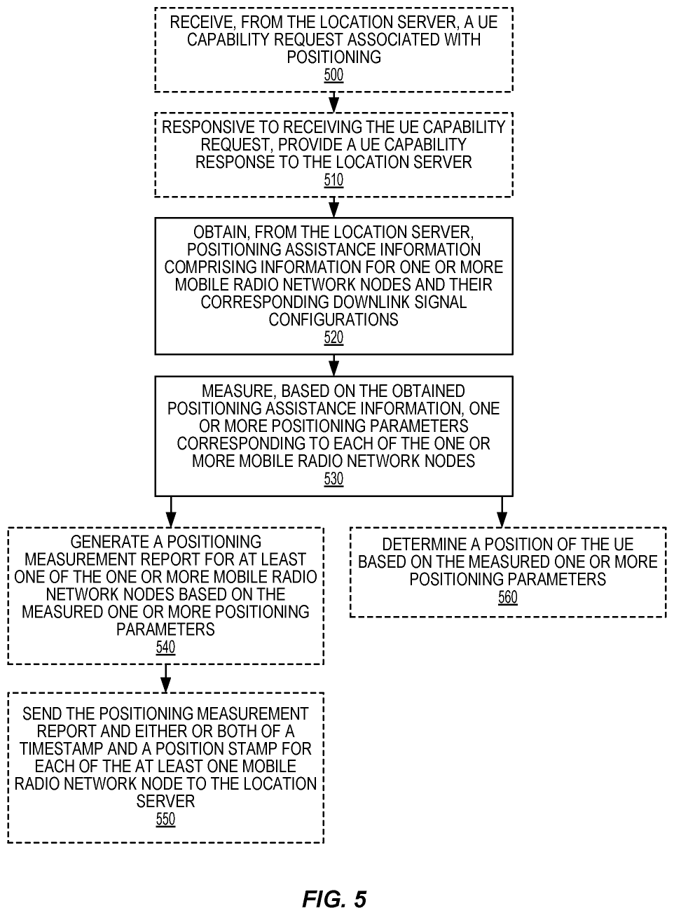

To illustrate operations of a UE, such as the UE 400 of FIGS. 4A and 4B, for measuring positioning parameters for at least one mobile radio network node, FIG. 5 is provided. In FIG. 5, operations according to some embodiments begin with the UE receiving, from a location server, a UE capability request associated with positioning (block 500). Responsive to receiving the UE capability request, the UE provides a UE capability response to the location server (block 510). In this example, the UE capability response includes information that indicates that the UE has the positioning capability described herein. The UE obtains, from the location server, positioning assistance information comprising information for one or more mobile radio network nodes and their corresponding downlink signal configurations, as described above (block 520). The UE measures one or more positioning parameters corresponding to each of at least one of the one or more mobile radio network nodes, as described above (block 530).

In some embodiments, the UE then generates a positioning measurement report for the at least one of the one or more mobile radio network nodes based on the one or more positioning parameters, as described above (block 540). The UE then sends the positioning measurement report and either or both of a timestamp and a position stamp for each of the at least one mobile radio network node to the location server, as described above (block 550). Some embodiments may provide that the UE alternatively or additionally determines a position of the UE based on the one or more positioning parameters, as described above (block 560).

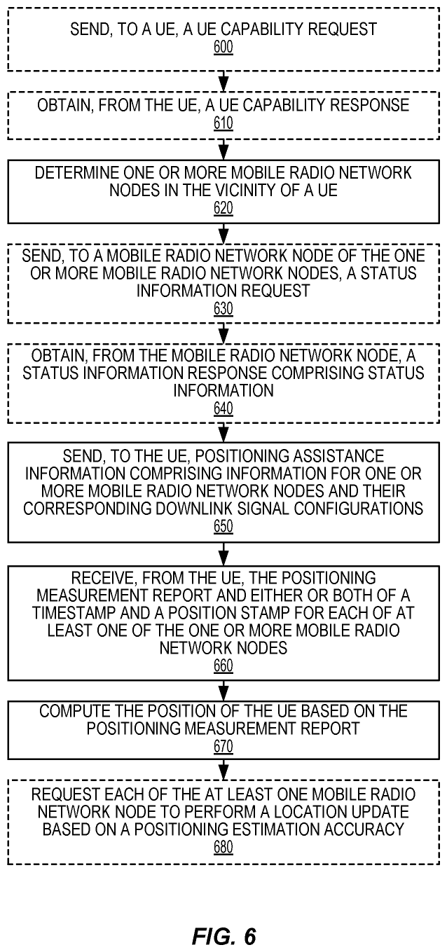

FIG. 6 is a flowchart illustrating operations of a location server, such as the location server 402 of FIGS. 4A and 4B, for computing the position of a UE based on a positioning measurement report provided by the UE. Operations in FIG. 6 begin with the location server in some embodiments sending, to a UE, a UE capability request (block 600). The location server subsequently obtains, from the UE, a UE capability response (block 610). The location server determines one or more mobile radio network nodes in the vicinity of a UE, as described above (block 620). In some embodiments, the location server sends, to a mobile radio network node of the one or more mobile radio network nodes, a status information request (block 630). The location server may then obtain, from the mobile radio network node, a status information response comprising status information, as described above (block 640).

The location server sends, to the UE, positioning assistance information comprising information for the one or more mobile radio network nodes and their corresponding downlink signal configurations, as described above (block 650). The location server next receives, from the UE, the positioning measurement report and either or both of a timestamp and a position stamp for each of at least one of the one or more mobile radio network nodes, as described above (block 660). The location server then computes the position of the UE based on the positioning measurement report, as described above (block 670). In some embodiments, the location server requests each of the at least one mobile radio network node to perform a location update based on a positioning estimation accuracy of the UE (block 680).

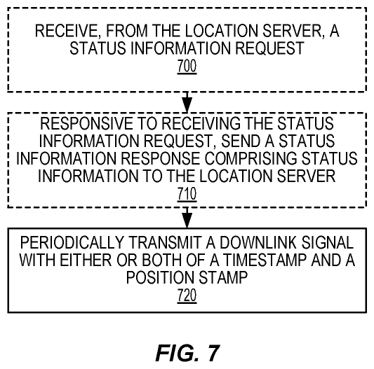

To illustrate operations of a mobile radio network node, such as the mobile radio network node 404 of FIGS. 4A and 4B, for providing a downlink signal and, optionally, a status information response for use in positioning measurement reporting, FIG. 7 is provided. In some embodiments, operations in FIG. 7 begin with the mobile radio network node receiving, from a location server, a status information request (block 700). Responsive to receiving the status information request, the mobile radio network node sends a status information response comprising status information to the location server, as described above (block 710). The mobile radio network node periodically transmits a downlink signal with either or both of a timestamp and a position stamp (block 720).

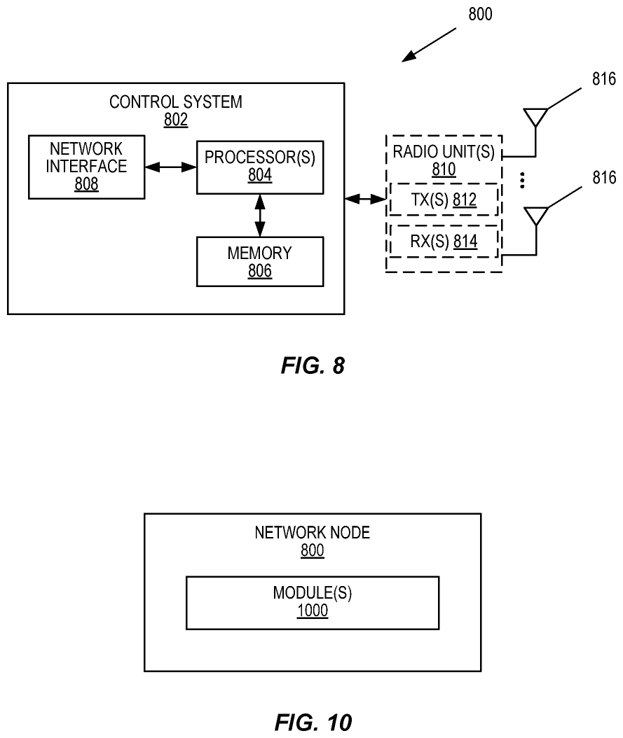

FIG. 8 is a schematic block diagram of a radio access node 800 according to some embodiments of the present disclosure. The radio access node 800 may be, for example, a base station 202 or 206. As illustrated, the radio access node 800 includes a control system 802 that includes one or more processors 804 (Application Specific Integrated Circuits, Field Programmable Gate Arrays, and/or the like), memory 806, and a network interface 808. The one or more processors 804 are also referred to herein as processing circuitry. In addition, the radio access node 800 includes one or more radio units 810 that each include one or more transmitters 812 and one or more receivers 814 coupled to one or more antennas 816. The radio units 810 may be referred to as, or be part of, radio interface circuitry. In some embodiments, the radio unit(s) 810 is external to the control system 802 and connected to the control system 802 via, e.g., a wired connection. However, in some other embodiments, the radio unit(s) 810 and potentially the antenna(s) 816 are integrated together with the control system 802. The one or more processors 804 operate to provide one or more functions of a radio access node 800 as described herein. In some embodiments, the function(s) are implemented in software that is stored, e.g., in the memory 806 and executed by the one or more processors 804.

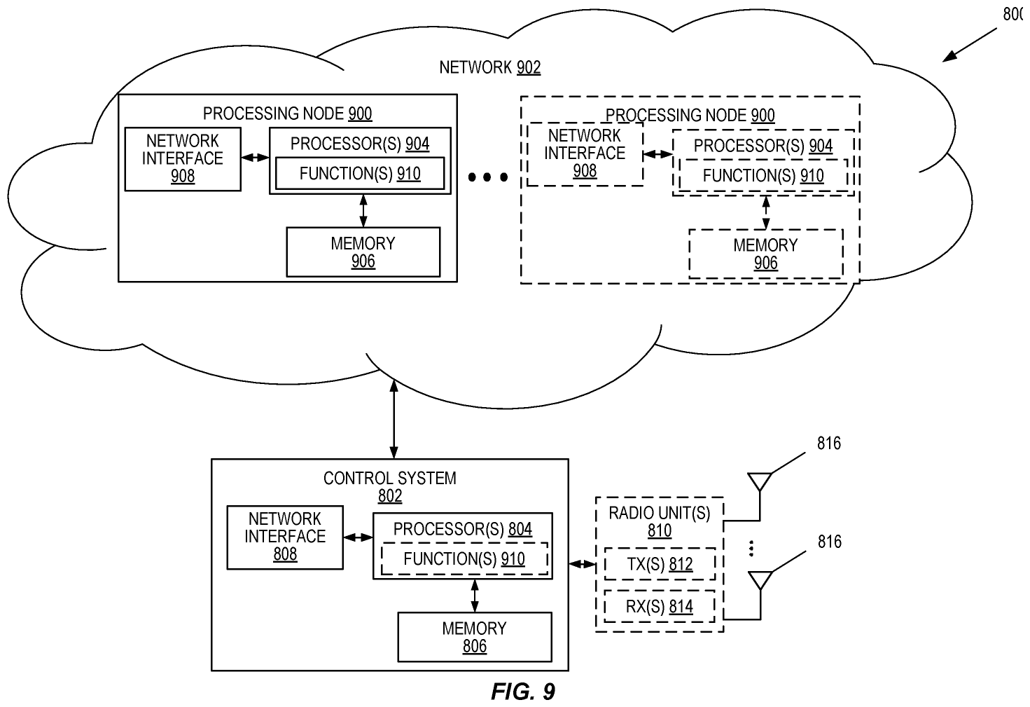

FIG. 9 is a schematic block diagram that illustrates a virtualized embodiment of the radio access node 800 according to some embodiments of the present disclosure. This discussion is equally applicable to other types of network nodes. Further, other types of network nodes may have similar virtualized architectures.

As used herein, a “virtualized” radio access node is an implementation of the radio access node 800 in which at least a portion of the functionality of the radio access node 800 is implemented as a virtual component(s) executing on a physical processing node(s) in a network(s). As illustrated, in this example, the radio access node 800 includes the control system 802 that includes the one or more processors 804, the memory 806, and the network interface 808, and the one or more radio units 810 that each includes the one or more transmitters 812 and the one or more receivers 814 coupled to the one or more antennas 816, as described above. The control system 802 is connected to the radio unit(s) 810 via, for example, an optical cable or the like. The control system 802 is connected to one or more processing nodes 900 coupled to or included as part of a network(s) 902 via the network interface 908. Each processing node 900 includes one or more processors 904, memory 906, and a network interface 908.

In this example, functions 910 of the radio access node 800 described herein are implemented at the one or more processing nodes 900 or distributed across the control system 802 and the one or more processing nodes 900 in any desired manner. In some particular embodiments, some or all of the functions 910 of the radio access node 800 described herein are implemented as virtual components executed by one or more virtual machines implemented in a virtual environment(s) hosted by the processing node(s) 900. As will be appreciated by one of ordinary skill in the art, additional signaling or communication between the processing node(s) 900 and the control system 802 is used in order to carry out at least some of the desired functions 910. Notably, in some embodiments, the control system 802 may not be included, in which case the radio unit(s) 810 communicate directly with the processing node(s) 900 via an appropriate network interface(s).

In some embodiments, a computer program including instructions which, when executed by at least one processor, cause the at least one processor to carry out the functionality of radio access node 800 or a node implementing one or more of the functions 910 of the radio access node 800 in a virtual environment according to any of the embodiments described herein is provided. In some embodiments, a carrier comprising the aforementioned computer program product is provided. The carrier is one of an electronic signal, an optical signal, a radio signal, or a non-transitory computer readable storage medium.

FIG. 10 is a schematic block diagram of the radio access node 800 according to some other embodiments of the present disclosure. The radio access node 800 includes one or more module(s) 1000, each of which is implemented in software. The module(s) 1000 provide the functionality of the radio access node 800 described herein. This discussion is equally applicable to the processing node(s) 900 of FIG. 9 where the module(s) 1000 may be implemented at one of the processing nodes 900 or distributed across multiple processing node(s) 900 and/or distributed across the processing node(s) 900 and the control system 802.

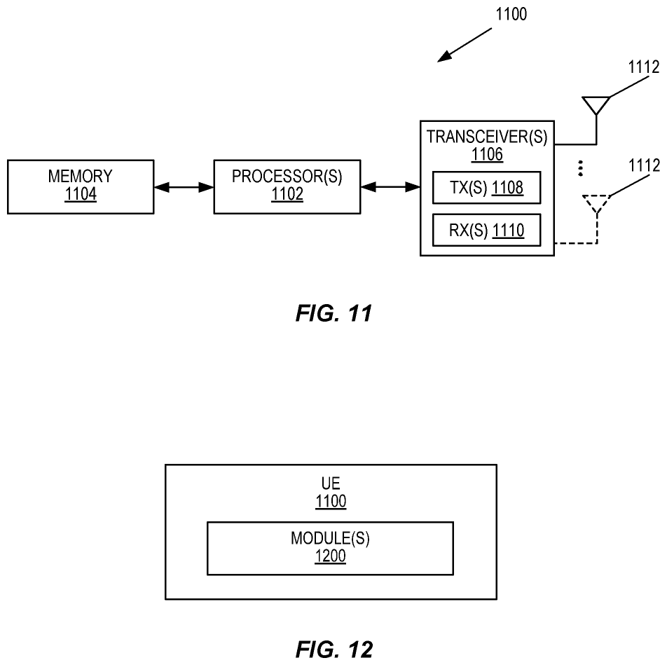

FIG. 11 is a schematic block diagram of a UE 1100 according to some embodiments of the present disclosure. As illustrated, the UE 1100 includes one or more processors 1102, memory 1104, and one or more transceivers 1106 each including one or more transmitters 1108 and one or more receivers 1110 coupled to one or more antennas 1112. The transceiver(s) 1106 includes radio-front end circuitry connected to the antenna(s) 1112 that is configured to condition signals communicated between the antenna(s) 1112 and the processor(s) 1102, as will be appreciated by one of ordinary skill in the art. The one or more processors 1102 are also referred to herein as processing circuitry. The transceivers 1106 are also referred to herein as radio circuitry. In some embodiments, the functionality of the UE 1100 described above may be fully or partially implemented in software that is, e.g., stored in the memory 1104 and executed by the processor(s) 1102. Note that the UE 1100 may include additional components not illustrated in FIG. 11 such as, e.g., one or more user interface components, and/or the like and/or any other components for allowing input of information into the UE 1100 and/or allowing output of information from the UE 1100, a power supply, etc.

In some embodiments, a computer program including instructions which, when executed by at least one processor, causes the at least one processor to carry out the functionality of the UE 1100 according to any of the embodiments described herein is provided. In some embodiments, a carrier comprising the aforementioned computer program product is provided. The carrier is one of an electronic signal, an optical signal, a radio signal, or a computer readable storage medium.

FIG. 12 is a schematic block diagram of the UE 1100 according to some other embodiments of the present disclosure. The UE 1100 includes one or more module(s) 1200, each of which is implemented in software. The module(s) 1200 provide the functionality of the UE 1100 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
AP Access Point
ASIC Application Specific Integrated Circuit
BSC Base Station Controller
BTS Base Transceiver Station
CD Compact Disk
COTS Commercial Off-the-Shelf
CPE Customer Premise Equipment
CPU Central Processing Unit
D2D Device-to-Device
DAS Distributed Antenna System
DSP Digital Signal Processor
DVD Digital Video Disk
eNB Enhanced or Evolved Node B
E-SMLC Evolved Serving Mobile Location Center
FPGA Field Programmable Gate Array
GHz Gigahertz
gNB New Radio Base Station
GSM Global System for Mobile Communications
IoT Internet of Things
IP Internet Protocol
LEE Laptop Embedded Equipment
LME Laptop Mounted Equipment
LTE Long Term Evolution
M2M Machine-to-Machine
MANO Management and Orchestration
MCE Multi-Cell/Multicast Coordination Entity
MDT Minimization of Drive Tests
MIMO Multiple Input Multiple Output
MME Mobility Management Entity
MSC Mobile Switching Center
MSR Multi-Standard Radio
MTC Machine Type Communication
NB-IoT Narrowband Internet of Things
NFV Network Function Virtualization
NIC Network Interface Controller
NR New Radio
O&M Operation and Maintenance
OSS Operations Support System
OTT Over-the-Top
PDA Personal Digital Assistant
P-GW Packet Data Network Gateway
RAM Random Access Memory
RAN Radio Access Network
RAT Radio Access Technology
RF Radio Frequency
RNC Radio Network Controller
ROM Read Only Memory
RRH Remote Radio Head
RRU Remote Radio Unit
SCEF Service Capability Exposure Function
SOC System on a Chip
SON Self-Organizing Network
UE User Equipment
USB Universal Serial Bus
V2I Vehicle-to-Infrastructure
V2V Vehicle-to-Vehicle
V2X Vehicle-to-Everything
VMM Virtual Machine Monitor
VNE Virtual Network Element
VNF Virtual Network Function
VoIP Voice over Internet Protocol
WCDMA Wideband Code Division Multiple Access
WiMax Worldwide Interoperability for Microwave Access

Those skilled in the art will recognize improvements and modifications to the embodiments of the present disclosure. All such improvements and modifications are considered within the scope of the concepts disclosed herein.

### REFERENCES

[1] “3rd Generation Partnership Project; Technical Specification Group Radio Access Network; Evolved Universal Terrestrial Radio Access (E-UTRA); LTE Positioning Protocol (LPP) (Release 15),” Technical Specification 36.355, v. 15.2.0 (December 2018).

[2] “3rd Generation Partnership Project; Technical Specification Group Radio Access Network; Evolved Universal Terrestrial Radio Access (E-UTRA); LTE Positioning Protocol A (LPPa) (Release 15),” Technical Specification 36.455, v. 15.2.1 (January 2019).

[3] “3rd Generation Partnership Project; Technical Specification Group Radio Access Network; Evolved Universal Terrestrial Radio Access (E-UTRA); Radio Resource Control (RRC); Protocol specification (Release 15),” Technical Specification 36.331, v. 15.4.0 (December 2018).

[4] “3rd Generation Partnership Project; Technical Specification Group Core Network and Terminals; Location Services (LCS); LCS Application Protocol (LCS-AP) between the Mobile Management Entity (MME) and Evolved Serving Mobile Location Centre (E-SMLC); SLs interface (Release 15),” Technical Specification 29.171, v. 15.2.0 (March 2019).

[5] “3rd Generation Partnership Project; Technical Specification Group Core Network and Terminals; Location Services (LCS); Evolved Packet Core (EPC) LCS Protocol (ELP) between the Gateway Mobile Location Centre (GMLC) and the Mobile Management Entity (MME); SLg interface (Release 15),” Technical Specification 29.172, v. 15.0.0 (June 2018).

[6] “3rd Generation Partnership Project; Technical Specification Group Radio Access Network; Evolved Universal Terrestrial Radio Access Network (E-UTRAN); Stage 2 functional specification of User Equipment (UE) positioning in E-UTRAN (Release 15),” Technical Specification 36.305, v. 15.2.0 (December 2018).

1-24. (canceled)

25. A method performed by a user equipment, UE, in a wireless communication system for enabling positioning measurement reporting for radio access nodes in a cellular communications network connected via wireless backhaul, wherein the radio access node is mobile, the method comprising:
obtaining, from a location server, positioning assistance information comprising information for one or more radio access nodes and their corresponding downlink signal configurations;
measuring, based on the obtained positioning assistance information, one or more positioning parameters associated with each of at least one radio access node, the at least one radio access node being at least one of the one or more radio access nodes for which the positioning assistance information was obtained;
generating a positioning measurement report for the at least one radio access node based on the measured one or more positioning parameters; and
sending, to the location server, the positioning measurement report and either or both of a timestamp and a position stamp for each of the at least one radio access node to the location server.

26. A user equipment, UE, comprising:
a transceiver; and processing circuitry associated with the transceiver, the processing circuitry configured to:
obtain, from a location server in a communication system, positioning assistance information comprising information for one or more radio access nodes and their corresponding downlink signal configurations, wherein the radio access node is mobile;
measure, based on the obtained positioning assistance information, one or more positioning parameters associated with each of at least one radio access node, the at least one radio access node being at least one of the one or more radio access nodes for which the positioning assistance information was obtained;
generate a positioning measurement report for the at least one radio access node based on the measured one or more positioning parameters; and
send, to the location server, the positioning measurement report and either or both of a timestamp and a position stamp for each of the at least one radio access node to the location server.

27. The UE of claim 26, wherein the processing circuitry is configured to:
determine a position of the UE based on the measured one or more positioning parameters.

28. The UE of claim 27, wherein the processing circuitry is configured to:
perform the determining of the position of the UE further based on a downlink signal from the at least one radio access node and either or both of a timestamp and a position stamp for each of the at least one radio access node, wherein:
the downlink signal comprises either or both of the timestamp and the position stamp;
the timestamp is indicative of a time of transmission of the downlink signal by the corresponding at least one radio access node; and
the position stamp is indicative of a position of the corresponding at least one radio access node at the time of transmission of the downlink signal by the corresponding at least one radio access node.

29. The UE of claim 27 wherein the processing circuitry is configured to:
determine the position of the UE, further based on a position for each of the at least one radio access node, at a corresponding time of transmission of a downlink signal by each of the at least one radio access node, obtained from the positioning assistance information.

30. The UE of claim 26, wherein the processing circuitry is configured to:
receive, prior to obtaining the positioning assistance information from the location server, a UE capability request associated with positioning; and
provide, to the location server, responsive to receiving the UE capability request, a UE capability response indicating the UE's capability for performing and reporting measurements for the one or more radio access nodes.

31. The UE of claim 26, wherein the one or more positioning parameters comprises:
a time of arrival of a downlink signal of a first radio access node of the at least one radio access node;
a difference in time of arrival of a downlink signal of a second radio access node of the at least one radio access node and a downlink signal of a fixed radio network node;
a difference in time of arrival of downlink signals of a third radio access node and a fourth radio access node of the at least one radio access node;
a received signal strength of a fifth radio access node of the at least one radio access node; and/or
an angle of arrival of a sixth radio access node of the at least one radio access node.

32. A network node comprising:
a network interface; and
processing circuitry associated with the network interface, the processing circuitry configured to:
determine one or more radio access nodes in a vicinity of a user equipment, UE, in a communication system;
send, to the UE, positioning assistance information comprising information for the one or more radio access nodes and their corresponding downlink signal configurations;
receive, from the UE, a positioning measurement report and either or both of a timestamp and a position stamp for each of at least one radio access node, the at least one radio access node being at least one of the one or more radio access nodes for which the positioning assistance information was sent, wherein the timestamp is indicative of a time of transmission of a downlink signal by the corresponding at least one radio access node, and the position stamp is indicative of a position of the corresponding at least one radio access node at the time of transmission of the downlink signal by the corresponding at least one radio access node; and
compute the position of the UE based on the positioning measurement report.

33. The network node of claim 32, wherein the processing circuitry is configured to:
determine the one or more radio access nodes in the vicinity of the UE based on one or more serving cell identities, IDs.

34. The network node of claim 32, wherein the processing circuitry is configured to:
send, to the UE, a UE capability request;
obtain, from the UE, a UE capability response indicating the UE's capability for performing and reporting measurements for the one or more radio access nodes; and
determine the one or more radio access nodes in the vicinity of the UE based on the UE capability response.

35. The network node of claim 32, wherein the processing circuitry is configured to, subsequent to determining the one or more radio access nodes in the vicinity of the UE:
send, to a radio access node of the one or more radio access nodes, a status information request; and
obtain, from the radio access node of the one or more radio access nodes, a status information response comprising status information.

36. The network node of claim 32, wherein the processing circuitry is configured to:
send the positioning assistance information by:
sending conventional location assistance information signal; or
sending location assistance information signal corresponding only to the one or more radio access nodes.

37. The network node of claim 35, wherein the processing circuitry is configured to:
request each of the at least one radio access node to perform a location update based on a positioning estimation accuracy of the UE.

38. The network node of claim 35, wherein the status information comprises:
an indication of whether the radio access node is transmitting a downlink signal;
an indication of whether the radio access node is moving;
an indication of a speed of the radio access node;
one or more position reports with a corresponding one or more timestamps;
a downlink signal configuration of the radio access node;
a corresponding fixed macro-cell deployment; and/or
an indication of whether the radio access node is a relaying node or is capable of operating as a reference node for user equipment, UE, positioning.

39. The network node of claim 38, wherein the one or more position reports is based on:
a latitude and a longitude of the radio access node;
a trajectory of the radio access node;
an internal measurement unit, IMU, of the radio access node;
one or more distances to corresponding one or more neighboring network nodes of the radio access node; and/or
one or more positions of the corresponding one or more neighboring network nodes of the radio access node.

40. A radio access node comprising:
a network interface; and
processing circuitry associated with the network interface, the processing circuitry configured to:
periodically transmit a downlink signal with either or both of a timestamp and a position stamp, wherein the timestamp is indicative of a time of transmission of the downlink signal by the radio access node, and the position stamp is indicative of a position of the radio access node at the time of transmission of the downlink signal.

41. The radio access node of claim 40, wherein the processing circuitry is configured to:
receive, from a location server, a status information request; and
send, responsive to receiving the status information request from the location server, a status information response comprising status information to the location server.

42. The network node of claim 41, wherein the status information comprises:
an indication of whether the radio access node is transmitting a downlink signal;
an indication of whether the radio access node is moving;
an indication of a speed of the radio access node;
one or more position reports with a corresponding one or more timestamps;
a downlink signal configuration of the radio access node;
a corresponding fixed macro-cell deployment; and/or
an indication of whether the radio access node is a relaying node or is capable of operating as a reference node for user equipment, UE, positioning.

43. The network node of claim 42, wherein the one or more position reports is based on:
a latitude and a longitude of the radio access node;
a trajectory of the radio access node;
an internal measurement unit, IMU, of the radio access node;
one or more distances to corresponding one or more neighboring network nodes of the radio access node; and/or
one or more positions of the corresponding one or more neighboring network nodes of the radio access node.

44. The radio access node of claim 42, wherein the one or more position reports is based on:
the latitude and the longitude of the radio access node based on a Wi-Fi beacon and/or a Bluetooth beacon.
